(19) United States
(12) Patent Application Publication
(10) Pub. No.: US 2023/0392941 A1
(43) Pub. Date: Dec. 7, 2023

(54) SYSTEM AND METHOD FOR OPERATING A PERSONAL ENERGY CONSUMPTION ACCOUNT FOR A USER

(71) Applicant: GM GLOBAL TECHNOLOGY OPERATIONS LLC, Detroit, MI (US)

(72) Inventors: Claudia V. Goldman-Shenhar, Mevasseret Zion (IL); Sharon Hornstein, Pardes Hanna (IL)

(73) Assignee: GM GLOBAL TECHNOLOGY OPERATIONS LLC, Detroit, MI (US)

(21) Appl. No.: 17/830,803

(22) Filed: Jun. 2, 2022

(51) Int. Cl. G01C 21/34; G07C 5/00

(52) U.S. Cl. CPC G01C 21/3469; G07C 5/008

(57) ABSTRACT

A system for operating a personal energy consumption account for a user includes a mobile application adapted to interface with the user and provide access to the personal energy consumption account. A controller is in communication with the mobile application. The controller is configured to obtain respective activity data of the user in a plurality of domains. The controller is configured to calculate respective carbon dioxide emissions for the plurality of domains. The plurality of domains is grouped into one or more energy clusters each defining a respective range of carbon dioxide emissions. The controller is configured to determine a respective score for the one or more energy clusters based in part on the respective carbon dioxide emissions, a respective average population consumption value and a respective energy budget. The controller is configured to generate recommendations for the user to improve the respective score.

### INTRODUCTION

The present disclosure relates generally to a system and corresponding method for operating a personal energy consumption account for a user. The use of fossil fuels and various other products causes the release of greenhouse gases, which poses a tremendous challenge to humanity. This is a large-scale problem, with multiple facets. Quantifying an individual's actions and behavior in terms of its effect on the environment is not a trivial matter. Accordingly, it may be difficult for an individual to understand the effect of their daily actions and behavior on climate issues such as global warming.

### SUMMARY

Disclosed herein is a system for operating a personal energy consumption account for a user. The system includes a mobile application adapted to interface with the user and provide access to the personal energy consumption account to the user. A controller is in communication with the mobile application, the controller having a processor and tangible, non-transitory memory on which instructions are recorded. The controller is configured to obtain respective activity data of the user in a plurality of domains. The controller is configured to calculate respective carbon dioxide emissions for the plurality of domains. The plurality of domains is grouped into one or more energy clusters each defining a respective range of carbon dioxide emissions. The controller is configured to determine a respective score for the one or more energy clusters based in part on the respective carbon dioxide emissions, a respective average population consumption value and a respective energy budget. The controller is configured to generate recommendations for the user to improve the respective score.

The mobile application may be embedded in a smart device belonging to the user. In some embodiments, the mobile application is accessible through a communications interface in a vehicle. The controller may be configured to represent the respective score as a visual graphic in the mobile application. In one embodiment, the visual graphic includes a tree such that the respective score is proportional to a number of leaves on the tree and/or a respective color of the leaves.

The controller may be configured to generate a user model based in part on the respective activity data of the user in the plurality of domains, the user model being a machine-learning model. The controller may be configured to personalize the recommendations based in part on the user model and selectively display the personalized recommendations in the mobile application.

In some embodiments, at least sensor is positioned on a respective item employed by the user in one of the plurality of domains. The respective item may be a recycling bin used by the user and the at least sensor is a weighing device operatively connected to the recycling bin. The plurality of domains may be selected by the user. The respective score may be determined for a current energy consuming activity in one of the plurality of domains.

Disclosed herein is a method of operating a system of personal energy consumption account for a user. The system has a controller with a processor and tangible, non-transitory memory on which instructions are recorded. The method includes a mobile application adapted to interface with the user and provide access to the personal energy consumption account. Respective activity data of the user is obtained in a plurality of domains, via the mobile application. The method includes calculating respective carbon dioxide emissions for the plurality of domains, via the controller. The plurality of domains is grouped into one or more energy clusters each defining a respective range of carbon dioxide emissions, via the controller. The method includes determining a respective score for the one or more energy clusters based in part on the respective carbon dioxide emissions, a respective average population consumption value and a respective energy budget, via the controller. The method includes generating recommendations for the user to improve the respective score.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary diagram of a system for operating a personal energy consumption account for a user;

FIG. 2 is a flowchart for an example method for operating the personal energy consumption account;

FIG. 3 is a schematic diagram of an example visualization of a respective score determined by the method of FIG. 2; and

FIG. 4 is a schematic diagram of another example visualization of a respective score determined by the method of FIG. 2.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

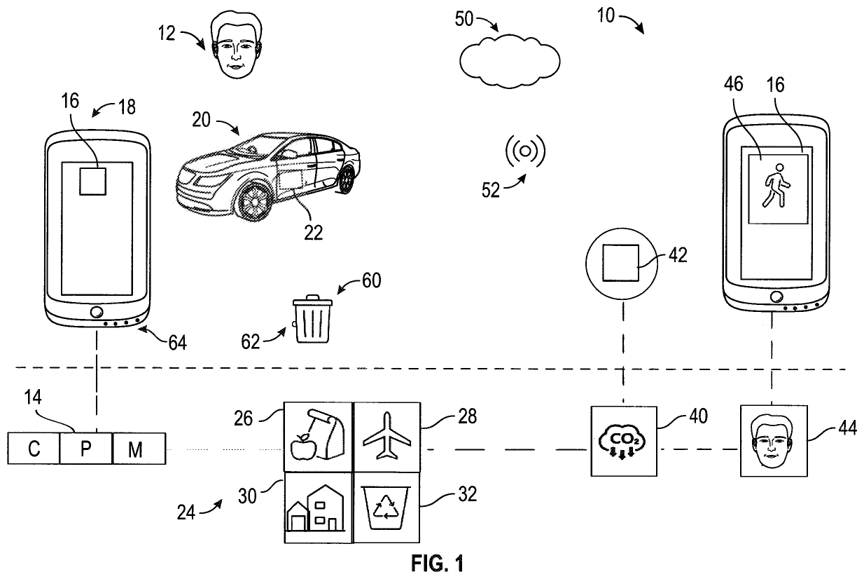

Referring to the drawings, wherein like reference numbers refer to like components, FIG. 1 schematically illustrates a system 10 for operating a personal energy consumption account 14 for a user 12. Referring to FIG. 1, the user 12 may access the personal energy consumption account 14 through a mobile application 16. The mobile application 16 may be embedded in a smart device 18, such as a smart phone or smart watch, belonging to the user 12. It is to be understood that the smart device 18 may take many different forms and have additional components.

Referring to FIG. 1, the mobile application 16 may be accessible through a vehicle 20 possessed by the user 12. For example, the mobile application 16 may be embedded in a communications interface 22 (e.g., the infotainment unit) of the vehicle 20. The vehicle 20 may include, but is not limited to, a passenger vehicle, sport utility vehicle, light truck, heavy duty vehicle, minivan, bus, transit vehicle, bicycle, moving robot, farm implement (e.g., tractor), sports-related equipment (e.g., golf cart) and micro-mobility transportation devices, such as scooters and electric bikes. The vehicle 20 may be an electric vehicle, which may be purely electric or hybrid/partially electric.

Personal energy consumption has an accumulative effect on our environment. It is difficult for humans to quantify the effect of their everyday actions on global warming, such as driving for a short trip to the store, turning on an air-conditioner or planting a tree. The system 10 facilitates maintenance of the personal energy consumption account 14 over combinations of the daily activities of the user 12. The advantage is that a large-scale problem is translated into personal low-level actions, conveying to the user 12 the effect of their decisions on the environment. This incentivizes the user 12 to prefer sustainable solutions over non-environmental ones.

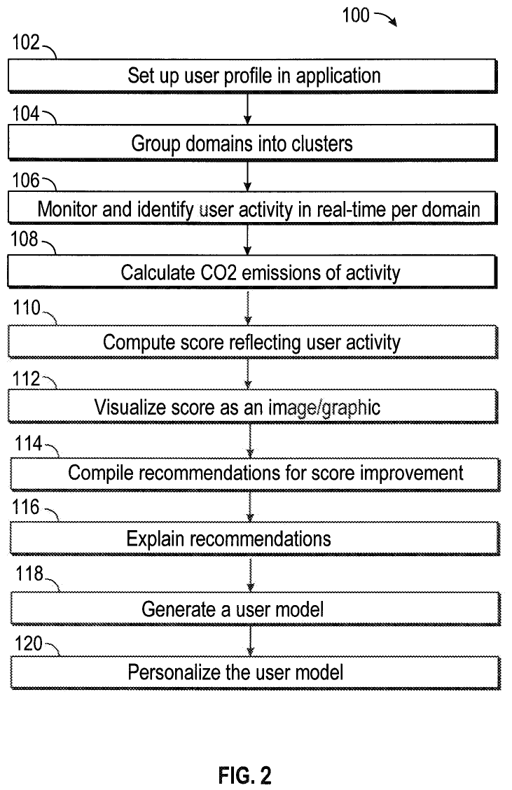

Referring to FIG. 1, the personal energy consumption account 14 may be operated by a control module having a controller C, at least one processor P and at least one memory M (or non-transitory, tangible computer readable storage medium). The memory M may store instructions for executing a method 100 (described below with respect to FIG. 2) for operating the personal energy consumption account 14. The controller C is in communication with the mobile application 16. The memory M can store controller-executable instruction sets, and the processor P can execute the controller-executable instruction sets stored in the memory M.

As described below, the controller C is configured to obtain respective activity data of the user 12 in a plurality of domains 24, as shown in FIG. 1. In one example, the plurality of domains 24 includes a food domain 26, a travel domain 28, a home domain 30 and a miscellaneous domain 32. Each domain includes further sub-domains. The system 10 monitors and identifies energy consuming activity taken from user preferences, calculates their respective carbon dioxide emissions 40 and computes a respective score 42 reflecting the effect of these activities. The score 42 may be visualized in a user-friendly manner, to motivate the user 12 to keep a balanced energy account. As described below, the system 10 generates a user model 44 for energy-related behavior and develops personalized recommendations 46 for future activities for the user 12 over a range of energy consuming activities.

The controller C of FIG. 1 may access data or information from a remotely located or “off-board” cloud computing service, referred to herein as cloud unit 50. The cloud unit 50 may include one or more servers hosted on the Internet to store, manage, and process data, maintained by an organization, such as for example, a research institute or a company. Referring to FIG. 1, the controller C may be configured to communicate with the cloud unit 50 via a wireless network 52.

The wireless network 52 of FIG. 1 may be a short-range network or a long-range network. The wireless network 52 may be a communication BUS, which may be in the form of a serial Controller Area Network (CAN-BUS). The wireless network 52 may incorporate a Bluetooth connection, a Wireless Local Area Network (LAN) which links multiple devices using a wireless distribution method, a Wireless Metropolitan Area Network (MAN) which connects several wireless LANs or a Wireless Wide Area Network (WAN). It is understood that other types of network and satellite technologies or communication protocols available to those skilled in the art may be employed.

Referring now to FIG. 2, a flowchart of a method 100 of operating the personal energy consumption account 14 is shown. Method 100 need not be applied in the specific order recited herein. Furthermore, it is to be understood that some blocks may be eliminated. In some embodiments, method 100 may be embodied as computer-readable code or stored instructions and may be at least partially executable by the controller C. Method 100 may be executed in real-time, continuously, systematically, sporadically and/or at regular intervals.

Method 100 may be executed in three stages. The first stage (blocks 102 and 104) includes the setting up of domains and collection of user data. The second stage (blocks 106 through 112) includes the computing of emissions and generation of scores for each energy cluster. The third stage (blocks 114 through 120) may include the development of concrete recommendations personal to the user 12 based on analysis of the data gathered.

Beginning at block 102 of FIG. 2, the method 100 includes setting up a profile of the user 12 in the mobile application 16. For example, the mobile application 16 may include an initial survey for the user 12 regarding activities in a plurality of domains 24. As noted above, the plurality of domains 24 may include a food domain 26, a travel domain 28, a home domain 30 and a miscellaneous domain 32. Each domain includes further sub-domains. It is understood that the number and type of domains and sub-domains may be selected based on the application at hand. The mobile application 16 is configured to ask the user 12 to choose the domains and/or sub-domains to monitor.

In one embodiment, the food domain 26 may include the following sub-domains: the composition of the diet of the user 12 such as food purchased from restaurants, canteens and takeaways and home-cooked foods, the presence of local versus imported foods in the diet of the user 12 and food waste (estimated by weight, e.g., an estimate of waste thrown in the garbage). The sub-domains in the travel domain 28 may include the following sub-domains: the vehicle 20 owned by the user 12, the type of vehicle 20 (e.g., sport, sedan, SUV), whether the vehicle 20 is fully or partially electric or has an internal combustion engine, the mileage and energy consumption particulars of the vehicle 20, airline flights taken by the user 12, green mobility habits such as cycling, walking, car-sharing rides, and mileage/time spent using public transportation.

The home domain 30 may include the following sub-domains: number of people living at the home of the user 12, heating mechanism in the home (e.g., electricity, wood, oil etc.), electricity saving equipment and habits, the average home temperature in winter and summer, the presence or absence of solar heating or solar panels that convert sun energy to electricity and the installation of energy efficiency improvement devices. The miscellaneous domain 32 may include the following sub-domains: recycling habits (amount and type of material recycled) of the user 12, purchase of household items (frequency and type), purchase of clothes and footwear, and the purchase of health and beauty items.

Also, per block 102, the user 12 may be asked to establish settings such as whether the respective activities in the plurality of domains 24 is automatically recognized or needs to be entered manually through the mobile application 16. The mobile application 16 may further ask the user 12 (via the mobile application 16) to set a predetermined time period (e.g., daily or weekly or monthly) for receiving the respective score 42 (to be determined in block 110). The profile of the user 12 may be stored in the form of a barcode or machine-readable optical label. The barcode may be based on a radio-frequency identification (RFID) system that uses electromagnetic fields for identification and tracking.

Advancing to block 104 of FIG. 2, the controller C is adapted to cluster the plurality of domains 24 having similar emissions values. In other words, the plurality of domains 24 chosen to be monitored by the user 12 is grouped into one or more energy clusters. Each energy cluster defines a specific range or level of carbon dioxide emissions 40. The domains 24 that fall into that specific range of carbon dioxide emissions 40 are grouped into that energy cluster. The clustering may be done with information obtained globally. In other words, the clustering may not be specific to the user 12. For example, the yearly carbon dioxide emissions for a person in the domains of home electricity, food waste, food packaging, vacation flight and the use of an automobile for daily commute may respectively be about 0.18 tons, 0.13 tons, 0.182 tons, 0.53 tons and 7.2 tons. Here the domains of home electricity, food waste, food packaging may be clustered together since their yearly carbon dioxide emissions are on the same order of magnitude (0.18 tons, 0.13 tons, 0.182 tons).

Proceeding to block 106, the controller C is adapted to identify and automatically monitor user activity in the plurality of domains 24 (selected by the user 12) in block 102 in real time. For the home domain, the controller C may be adapted to monitor the electricity metering at the home of the user 12 and deduce the consumption of various home appliances. The home appliances in the home of the user 12 may be registered with the mobile application 16. For the travel domain 28, the controller C may be adapted to compare GPS data with speed and time difference, to deduce details transportation data. For the travel domain 28, the controller C may be configured to obtain data from a vehicle tracking application running in the vehicle 20. The vehicle tracking application may track distance traveled, speed profile, driving style (e.g., frequency of brake application), and amount and type (fuel or electric) of energy consumed.

In some embodiments, the controller C is adapted to obtain the respective activity data of the user 12 using various sensors attached to respective items used by the user 12. Referring to FIG. 1, for example, the respective item 60 may be a garbage can or recycling bin having a sensor 62 that is a weighing device. The smart device 18 may include a corresponding readers or detectors 64 that read the signal originating from the sensor 62 and other sensors.

Advancing to block 108 of FIG. 2, the method 100 includes calculating respective carbon dioxide emissions for the plurality of domains 24 that have been selected by the user 12 in block 102. A carbon dioxide emission calculator available to those skilled in the art may be employed.

Proceeding to block 110 of FIG. 2, the method 100 includes determining a respective score 42 for each of the energy clusters. First, the controller C obtains the user energy consumption value (U_{E}) for the user 12 for each energy cluster (or domain 24). Second, the controller C obtains or calculates an average population consumption value (U_{PE}) for that energy cluster, for example, through a database in the cloud unit 50 or via direct calculation. Third, a sigma value (a) is calculated, which may be defined as the interval between energy consumption levels that have an effect on the personal energy account. In one example, the sigma value (a) is calculated as follows: σ=CEILING (B/K), where B is a respective energy budget (B) for the energy cluster and K is a resolution factor for the energy cluster. The respective energy budget (B) and the resolution factor (K) may be expressed in terms of metric tons (tonnes).

The respective energy budget (B) reflects an idealized emission amount, in other words, what the user 12 may ideally spend energy-wise in that category. The respective energy budget (B) and resolution factor (K) may be selected by the controller C for each of the energy clusters. The system resolution (K) may be chosen to obtain a desired score resolution or spacing between the levels of allowed scores, depending on the order of magnitude of the budget (B). For example, if the respective energy budget (B) and the resolution factor (K) are 8 metric tons and 6 metric tons, respectively, then σ=CEILING (8/6)=1.

The score given to the user 12 may be discretized for a given budget for energy consumption, for a given domain 24. As shown in Table 1 below, a current score may be obtained by comparing the difference (U_{E}−U_{PE}) between the user energy consumption value (U_{E}) for the user 12 and the average population consumption value (U_{PE}) and the sigma value (α) for each energy cluster. The system 10 may be designed to allow a specific number of levels of allowed score. In the example shown in the table below, the score is designated to be an integer value in the range of positive 3 to negative 3 as follows: [+3, +2, +1, 0, −1, −2, −3]. The current score may be accumulated with previous scores given on past activities to obtain the respective score 42. Here ε is a value between zero and σ such that 0≤ε<σ. TABLE 1

| Difference (U_{E} − U_{PE}) | Current Score |
|---|---|
| (U_{E} − U_{PE}) > 3σ | 3 |
| (U_{E} − U_{PE}) > 2σ | 2 |
| (U_{E} − U_{PE}) > σ | 1 |
| (U_{E} − U_{PE}) > ε | 0 |
| (U_{E} − U_{PE}) < σ | −1 |
| (U_{E} − U_{PE}) < 2σ | −2 |
| (U_{E} − U_{PE}) < 3σ | −3 |

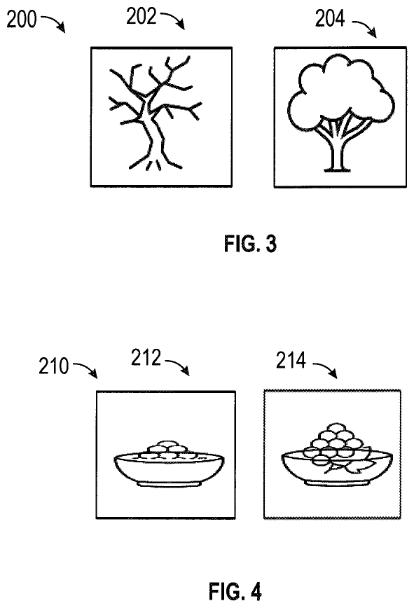

Advancing to block 112 of FIG. 2, the method 100 may include representing the respective score 42 as a visual graphic. FIG. 3 shows an example visualization 200 with a first graphic 202 and a second graphic 204, reflecting different scores. The visualization 200 includes a tree such that the respective score is proportional to the number of leaves on the tree and/or a respective color of the leaves. The first graphic 202 shows a dried out or parched tree representing a lower score, while the second graphic 204 shows a healthy tree with many leaves representing a higher score. Similarly, FIG. 4 shows another example visualization 210 depicting a bowl of grapes such that the respective score is proportional to the number of grapes in the bowl. Referring to FIG. 4, the first graphic 212 (with fewer grapes) and the second graphic 214 (with more grapes) represent a lower score and a higher score, respectively. The respective score 42 is presented in a user-friendly manner to increase awareness and to motivate the user 12 to improve their energy consumption balance.

Proceeding to block 114 of FIG. 2, the controller C is adapted to compile recommendations or recommended activities for score improvement. For a given energy cluster having a respective score 42 at a specific time, the controller C is adapted to compute the respective carbon dioxide emissions 40 for a set of potential activities that lead to an improved score. In one embodiment, the recommendations include each of those activities that lead to the improved score, with the activities being sorted or listed in order of increasing score.

Advancing to block 116 of FIG. 2, the controller C is adapted to provide an explanation of the recommendations. In other words, for each recommended activity that has an original score, an explanation of factors is provided that would result in a significantly improved score (relative to the original score). The controller C may incorporate a suitable explainable artificial intelligence (XAI) algorithm available to those skilled in the art. Explainable artificial intelligence or explainable machine learning is understood to be artificial intelligence in which the results of the solution may be understood by humans. Explainable artificial intelligence is an attempt to add transparency to the results of non-linearly programmed systems.

Proceeding to block 118 of FIG. 2, the method 100 includes generating a user model 44. The user model 44 may be a machine-learning model that is trained using historical data. The inputs to the user model 44 may include a specific activity at a specific date and time, its respective carbon dioxide emissions 40, and its respective score 42 and other context parameters. The outputs of the user model 44 include the probability of the specific activity happening in a certain context.

In one example, the user model 44 incorporates a neural network with an activation function in an output layer, the activation function predicting a multinomial probability distribution. As understood by those skilled in the art, neural networks are designed to recognize patterns from real-world data (e.g., images, sound, text, time series and others), translate or convert them into numerical form and embed in vectors or matrices. The neural network may employ deep learning maps to match an input vector x to an output vector y. In other words, the neural network learns an activation function f such that f(x) maps toy. The training process enables the neural network to correlate the appropriate activation function f(x) for transforming the input vector x to the output vector y. In the case of a simple linear regression model, two parameters are learned: a bias and a slope. The bias is the level of the output vector y when the input vector x is 0 and the slope is the rate of predicted increase or decrease in the output vector y for each unit increase in the input vector x.

Advancing to block 120 of FIG. 2, the method 100 includes personalizing the recommendations 46 compiled in block 114, based on the user model 44 generated in block 118. Based on the user model 44, the recommendations 46 may include the activity that has the maximal likelihood of being accepted by the user 12. The recommendations 46 may be based on historical data or patterns from the specific to the user 12 as well as data from other users. In some cases, data accessible from the Internet may be employed. For example, a municipality in a city may add new recycling bins in a certain area. These recycling bins may be identified by a network (e.g., IOT), with new data flowing to the mobile application 16, which adds these recycling bins to motivate the user 12 to recycle the waste instead of throwing it in the regular garbage.

The recommendations 46 may include specific recommendations of sustainable and eco-friendly individual behaviors, such as carpooling, cycling, or recycling. For example, a user 12 may be found to make multiple short trips on Fridays. The mobile application 16 may provide the following personalized recommendation 46; “Consider biking on Fridays to help reduce your CO2 emissions. On Fridays, it seems like you can bike short distances.” Similarly on weekdays, the mobile application 16 may recommend that the user 12 leave work one hour later to reduce their respective carbon dioxide emissions 40. The personalized recommendations 46 improve the balance between high-energy and low-energy consumption activities of the user 12.

In summary, the system 10 establishes and maintains a personal energy consumption account 14 for the individual that is user-friendly and personalized. The system 10 computes the energy consumption of a user 12 based on respective carbon dioxide emissions 40, translates this value to a respective score 42, explains this value and learns to recommend actions to the user 12 to balance the account. The system 10 may be adapted for multiple users such as families, communities and businesses. For example, the system 10 may be employed to help a fleet become more environmentally friendly by both analyzing their usage and modifying their fleets accordingly.

The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a group of files in a file system, an application database in a proprietary format, a relational database energy management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts illustrate an architecture, functionality, and operation of possible implementations of systems, methods, and computer program products of various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used here indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system of operating a personal energy consumption account for a user, the system comprising:
a mobile application adapted to interface with the user and provide access to the personal energy consumption account;
a controller in communication with the mobile application, the controller having a processor and tangible, non-transitory memory on which instructions are recorded, the controller being configured to:
obtain respective activity data of the user in a plurality of domains;
calculate respective carbon dioxide emissions for the plurality of domains;
group the plurality of domains into one or more energy clusters each defining a respective range of carbon dioxide emissions;
determine a respective score for the one or more energy clusters based in part on the respective carbon dioxide emissions, a respective average population consumption value and a respective energy budget; and
generate recommendations for the user to improve the respective score.

2. The system of claim 1, wherein the mobile application is embedded in a smart device belonging to the user and the plurality of domains is selected by the user.

3. The system of claim 1, wherein the mobile application is accessible through a communications interface in a vehicle.

4. The system of claim 1, wherein the controller is configured to represent the respective score as a visual graphic in the mobile application.

5. The system of claim 4, wherein the visual graphic includes a tree such that the respective score is proportional to a number of leaves on the tree and/or a respective color of the leaves.

6. The system of claim 1, wherein the controller is configured to generate a user model based in part on the respective activity data of the user in the plurality of domains, the user model being a machine-learning model.

7. The system of claim 6, wherein the controller is configured to personalize the recommendations based in part on the user model and selectively display the personalized recommendations in the mobile application.

8. The system of claim 1, further comprising:
at least sensor positioned on a respective item employed by the user in one of the plurality of domains.

9. The system of claim 8, wherein the respective item is a recycling bin used by the user and the at least sensor is a weighing device operatively connected to the recycling bin.

10. A method of operating a system of personal energy consumption account for a user, the system having a controller with a processor and tangible, non-transitory memory on which instructions are recorded, the method comprising:
a mobile application adapted to interface with the user and provide access to the personal energy consumption account;
obtaining respective activity data of the user in a plurality of domains, via the mobile application;
calculating respective carbon dioxide emissions for the plurality of domains, via the controller;
grouping the plurality of domains into one or more energy clusters each defining a respective range of carbon dioxide emissions, via the controller;
determining a respective score for the one or more energy clusters based in part on the respective carbon dioxide emissions, a respective average population consumption value and a respective energy budget, via the controller; and
generating recommendations for the user to improve the respective score.

11. The method of claim 10, further comprising:
embedding the mobile application in a smart device belonging to the user.

12. The method of claim 10, further comprising:
accessing the mobile application through a communications interface in a vehicle.

13. The method of claim 10, further comprising:
representing the respective score as a visual graphic in the mobile application.

14. The method of claim 13, further comprising:
presenting the visual graphic as a tree such that the respective score is proportional to a number of leaves on the tree and/or a respective color of the leaves.

15. The method of claim 10, further comprising:
generating a user model and personalizing the recommendations based in part on the user model, via the controller.

16. The method of claim 15, further comprising:
selectively displaying the personalized recommendations in the mobile application and explaining the personalized recommendations, via the controller.

17. A system of operating a personal energy consumption account for a user, the system comprising:
a mobile application adapted to interface with the user and provide access to the personal energy consumption account;
a controller in communication with the mobile application, the controller having a processor and tangible, non-transitory memory on which instructions are recorded, the controller being configured to:
obtain respective activity data of the user in a plurality of domains;
calculate respective carbon dioxide emissions for the plurality of domains;
group the plurality of domains into one or more energy clusters each defining a respective range of carbon dioxide emissions;
determine a respective score for the one or more energy clusters based in part on the respective carbon dioxide emissions, a respective average population consumption value and a respective energy budget.
represent the respective score as a visual graphic in the mobile application;
generate a user model based in part on the respective activity data of the user in the plurality of domains, the user model being a machine-learning model; and
compile personalized recommendations based in part on the user model and selectively display the personalized recommendations in the mobile application.

18. The system of claim 17, wherein the respective score is determined for a current energy consuming activity in one of the plurality of domains.
